(19) United States
(12) Patent Application Publication
(10) Pub. No.: US 2024/0098786 A1
(43) Pub. Date: Mar. 21, 2024

(54) END-TO-END ACKNOWLEDGEMENT IN A WIRELESS NETWORK

(71) Applicant: NXP USA, Inc., Austin, TX (US)

(72) Inventors: Kiseon Ryu, San Diego, CA (US); Liwen Chu, San Ramon, CA (US); Rui Cao, Sunnyvale, CA (US); Hongyuan Zhang, Fremont, CA (US)

(21) Appl. No.: 18/242,494

(22) Filed: Sep. 5, 2023

Related U.S. Application Data
(60) Provisional application No. 63/376,084, filed on Sep. 17, 2022.

(51) Int. Cl. H04W 74/08

(52) U.S. Cl. CPC H04W 74/0816; H04W 74/0866

(57) ABSTRACT

Embodiments of a method and apparatus for wireless communications are disclosed. In an embodiment, a wireless relay device includes a wireless transceiver configured to receive, from a first wireless device, a first multi-station (STA) block acknowledgement (BA) frame, and a controller configured to generate a second multi-STA BA frame in response to the first multi-STA BA frame. The wireless transceiver is further configured to transmit the second multi-STA BA frame to a second wireless device.

### CROSS-REFERENCE TO RELATED APPLICATIONS

This application is entitled to the benefit of U.S. Provisional Patent Application Ser. No. 63/376,084, filed on Sep. 17, 2022, which is incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). Some applications, for example, high definition (HD) video surveillance applications, outdoor video sharing applications, etc., require relatively high system throughput as well as good network coverage. However, typical range extension (ER) techniques provide limited wireless transmission range extension.

### SUMMARY

Embodiments of a method and apparatus for wireless communications are disclosed. In an embodiment, a wireless relay device includes a wireless transceiver configured to receive, from a first wireless device, a first block acknowledgement (BA) frame, and a controller configured to generate a second BA frame in response to the first BA frame. The wireless transceiver is further configured to transmit the second BA frame to a second wireless device. Other embodiments are also disclosed.

In an embodiment, at least one of the first BA frame and the second BA frame includes a receiver address (RA), a transmitter address (TA), and one of a source address (SA) and a destination address (DA).

In an embodiment, the SA or the DA is indicated in a Per Association Identifier (AID) Traffic Identifier (TID) information subfield in the at least one of the first BA frame and the second BA frame.

In an embodiment, the first and the second BA frames include Media Access Control (MAC) control frames.

In an embodiment, at least one of the first BA frame and the second BA frame includes a multi-station (STA) BA frame.

In an embodiment, the first and the second BA frames include address fields indicating MAC addresses of the first wireless device and the second wireless device.

In an embodiment, the second wireless device includes a wireless access point (AP), and the first wireless device includes a non-AP station (STA) device.

In an embodiment, the first BA frame includes a MAC header having a receiver address (RA) field that is set to a MAC address of the wireless relay device and a transmitter address (TA) field that is set to a MAC address of the non-AP STA device.

In an embodiment, the first BA frame includes a Per AID TID information subfield having a destination address (DA) field that is set to a MAC address of the wireless AP.

In an embodiment, the second BA frame includes a MAC header having a receiver address (RA) field that is set to a MAC address of the wireless AP and a transmitter address (TA) field that is set to a MAC address of the wireless relay device.

In an embodiment, the second BA frame includes a Per AID TID information subfield having a source address (SA) field that is set to a MAC address of the wireless non-AP STA device.

In an embodiment, the first wireless device includes a wireless AP, and the second wireless device includes a non-AP STA device.

In an embodiment, the wireless relay device is compatible with an Institute of Electrical and Electronics Engineers (IEEE) 802.11 protocol.

In an embodiment, the wireless transceiver is further configured to share a transmit opportunity (TXOP) of the second wireless device.

In an embodiment, the wireless transceiver is further configured to share the TXOP of the second wireless device in a multi-hop transmission, where the multi-hop transmission is conducted through an aggregated physical layer protocol data unit (PPDU).

In an embodiment, the aggregated PPDU includes a first PPDU and a second PPDU that is a relayed version of the first PPDU.

In an embodiment, a method for wireless communications involves receiving, from a first wireless device, a first BA frame, generating a second BA frame in response to the first BA frame, and transmitting the second BA frame to a second wireless device, where at least one of the first BA frame and the second BA frame includes a multi-STA BA frame having a receiver address (RA), a transmitter address (TA), and one of a source address (SA) and a destination address (DA), and where the first and the second BA frames include MAC control frames.

In an embodiment, the SA or the DA is indicated in a Per AID TID information subfield in the at least one of the first BA frame and the second BA frame.

In an embodiment, the first and the second BA frames include address fields indicating MAC addresses of the first wireless device and the second wireless device.

In an embodiment, the second wireless device includes a wireless AP, and the first wireless device includes a non-AP STA device.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system with relay transmission capabilities in accordance with an embodiment of the invention.

FIG. 2 depicts a frame exchange sequence diagram between a transmitter station (tSTA), a relay station (rSTA), and a destination station (dSTA).

FIG. 3 depicts an example format of a multi-STA block acknowledgement (BA) (also referred to as M-BA) frame.

FIG. 4 depicts an example Per Association Identifier (AID) Traffic Identifier (TID) Info subfield table.

FIG. 5 depicts a frame exchange sequence diagram between a tSTA, an rSTA, and a dSTA with M-BAs.

FIG. 6 depicts an example format of an M-BA frame.

FIG. 7 shows a swim-lane diagram illustrating an example acknowledgement procedure between an AP, a relay, and a non-AP STA.

FIG. 8 shows a swim-lane diagram illustrating an example acknowledgement procedure between an AP, a relay, and a non-AP STA.

FIG. 9 depicts a wireless device in accordance with an embodiment of the invention.

FIG. 10 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

Range extension (ER) PPDU formats are introduced from IEEE 802.11ax and carried over to IEEE 802.11be and beyond. Direct sequence spread spectrum (DSSS) is also defined in IEEE 802.11b in 2.4 GHz band with longer range. However, these ER physical layer (PHY) modes can extend the transmission range with limited 3 dB-6 dB, and the sustainable data rate is reduced to 1-3 mbps. Relay forwarding has been defined as independent transmission for each hop, which induced long latency and jitter. For example, typical WiFi extender/repeater/boosters have long end-to-end latency, high jitter, and low throughput. In a WiFi mesh router or EasyMesh program, each mesh router is interconnected with another mesh router through either wire or wireless. For wireless connection, every AP can relay the data from a master AP to its own stations (STAs). Each mesh node has a full function AP and at least one full function STA, thus is not cost effective. The AP relaying protocol is built on top of existing IEEE 802.11 Media Access Control (MAC)/PHY components, latency/jitter is also high compared to single-hop case. For IEEE 802.11 11ah/ad relaying mode, end to end latency and throughput may not be guaranteed with hop-by-hop block acknowledgement (BA)/acknowledgement (ACK) agreement and security protocol.

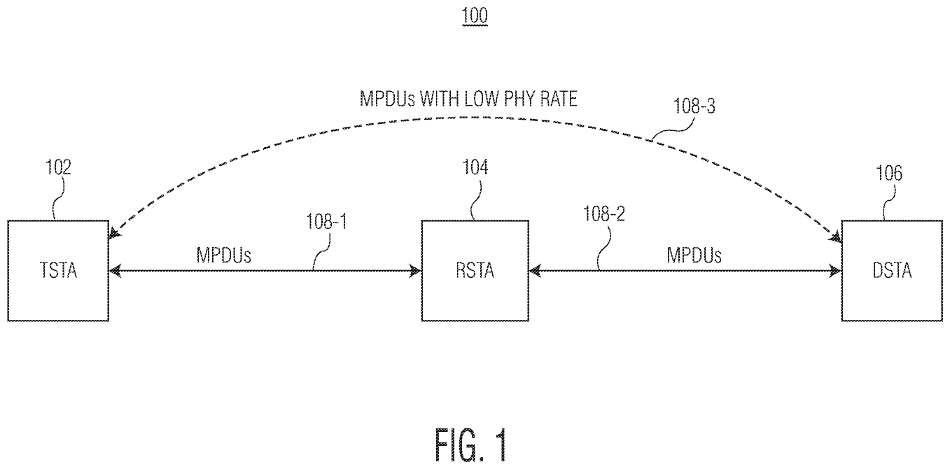

FIG. 1 depicts a wireless (e.g., WiFi) communications system 100 with relay transmission capabilities in accordance with an embodiment of the invention. In the embodiment depicted in FIG. 1, the wireless communications system 100 includes a transmitter station (tSTA) 102, a relay station (rSTA) 104, and a destination STA (dSTA) 106. The rSTA is located in the signal path between the tSTA and the dSTA and is configured to forward data between the tSTA and the dSTA. In some embodiments, the rSTA is configured to decode and forward data that is received from the tSTA to the dSTA and/or from the dSTA to the tSTA. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple tSTAs with one rSTA and one dSTA, multiple tSTAs with multiple rSTAs and one dSTA, multiple tSTAs with one rSTA and multiple dSTAs, multiple tSTAs with multiple rSTAs and multiple dSTAs, one tSTA with one rSTA and multiple dSTAs, or one tSTA with multiple rSTAs and multiple dSTAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the tSTA 102, the rSTA 104, and the dSTA 106 communicate through single communications links. In some embodiments, the wireless communications system 100 described with reference to FIG. 1 involves multi-link communications and the tSTA 102, the rSTA 104, and the dSTA 106 communicate through multiple communications links. Furthermore, the techniques described herein may also be applicable to each link of a multi-link communications system.

In the embodiment depicted in FIG. 1, the tSTA 102 may be implemented in hardware (e.g., circuits), software, firmware, or a combination thereof. The tSTA 102 may be fully or partially implemented as an integrated circuit (IC) device. In some embodiments, the tSTA 102 is a wireless access point (AP) compatible with at least one WLAN communications protocol (e.g., at least one IEEE 802.11 protocol). In some embodiments, the tSTA 102 is a wireless AP that connects to a local area network (LAN) and/or to a backbone network (e.g., the Internet) through a wired connection and that wirelessly connects to one or more wireless stations (STAs), for example, through one or more WLAN communications protocols, such as an IEEE 802.11 protocol. In some embodiments, the tSTA 102 includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the tSTA 102 (e.g., a controller or a transceiver of the tSTA 102) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one tSTA, other embodiments of the wireless communications system 100 may include multiple tSTAs. In these embodiments, each of the tSTAs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, the rSTA 104 and the dSTA 106 may be implemented in hardware (e.g., circuits), software, firmware, or a combination thereof. The rSTA 104 and the dSTA 106 may be fully or partially implemented as IC devices. In some embodiments, at least one of the rSTA 104 and the dSTA 106 is a communications device compatible with at least one IEEE 802.11 protocol. In some embodiments, at least one of the rSTA 104 and the dSTA 106 is implemented in a laptop, a desktop personal computer (PC), a mobile phone, or other communications device that supports at least one WLAN communications protocol. In some embodiments, at least one of the rSTA 104 and the dSTA 106 implements a common MAC data service interface and a lower layer MAC data service interface. In some embodiments, each of the rSTA 104 and the dSTA 106 includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the tSTA 102 (e.g., an AP) communicates with the rSTA 104 via a communication link 108-1 (e.g., a wireless link), and the rSTA 104 communicates with the dSTA 106 via a communication link 108-2 (e.g., a wireless link). The rSTA is located between the tSTA and the dSTA to forward data to the dSTA (e.g., decode and forward data received from the tSTA to the dSTA) and/or to forward data to the tSTA (e.g., decode and forward data received from the dSTA to the tSTA). In some embodiments, data communicated between the tSTA, the rSTA, and the dSTA includes MAC protocol data units (MPDUs). An MPDU may include a frame header, a frame body, and a trailer with the MPDU payload encapsulated in the frame body. When data transfer is performed with two channel access, the system throughput of the wireless communications system 100 depicted in FIG. 1 may be halved linearly. The rSTA provides flexibility to achieve higher rate with shorter communications links 108-1, 108-2. In some embodiments, the tSTA 102 (e.g., an AP) can directly communicate with the dSTA 106 via a communication link 108-3. Compared to the communications links 108-1, 108-2, the communication link 108-3 can have two times of distance, which corresponds to around 8 dB propagation loss (2.7 decaying exponent). To maintain the communication link 108-3, 8 dB better sensitivity and new PHY design is needed, the data rate is reduced to around ⅛ and physical layer protocol data unit (PPDU) airtime increases by 8 times. Although the tSTA 102 (e.g., an AP), the rSTA 104, and the dSTA 106 are depicted in FIG. 1 as wirelessly communicating to each other via a corresponding communications link 108-1, 108-2, or 108-3, in other embodiments, the tSTA 102, the rSTA 104, and the dSTA 106 may wirelessly communicate to each other via multiple communication links. In some embodiments, for point-to-point (P2P) communications, the tSTA 102 is implemented as another non-AP STA. In some embodiments, the rSTA 104 includes a relay STA that performs frame exchanges with the tSTA 102 and a relay AP that performs frame exchanges with the dSTA 106 and a relay functionality between the relay STA and the relay AP.

In some embodiments, the rSTA 104 is used when the associated tSTA 102 (e.g., an AP) cannot reach a faraway dSTA (e.g., the dSTA 106) with high Modulation and Coding Scheme (MCS), number of spatial streams (NSS) or cannot reach a faraway STA (e.g., the dSTA 106) with the lowest MCS. The uplink (UL) frame transmission between the dSTA and the tSTA 102 (e.g., an AP) may be done by PPDUs transmitted from the dSTA to the rSTA 104 and PPDUs transmitted by the rSTA to the tSTA 102 (e.g., an AP). The downlink (DL) frame transmission between the tSTA 102 (e.g., an AP) and the dSTA may be done by PPDUs transmitted by the tSTA 102 (e.g., an AP) to the rSTA and PPDUs transmitted by the rSTA to the dSTA. The block acknowledgement (BA)/acknowledgement (ACK) can be end-to-end or hop-by-hop. With end-to-end BA, the DL BA transmitted by the AP may acknowledge the soliciting UL Aggregate MAC Protocol Data Unit (A-MPDU)/block acknowledgement request (BAR) from the dSTA that is forwarded by the rSTA, and the DL BA transmitted by the tSTA 102 (e.g., an AP) may acknowledge the soliciting A-MPDU/BAR from the dSTA that is forwarded by the rSTA. With hop-by-hop DL BA, the DL BA transmitted by the tSTA 102 (e.g., an AP) may acknowledge the soliciting UL A-MPDU/BAR from the rSTA, and the DL BA transmitted by the rSTA may acknowledge the soliciting UL A-MPDU/BAR from the dSTA. With hop-by-hop UL BA, the UL BA transmitted by the rSTA may acknowledge the soliciting DL A-MPDU/BAR from the tSTA 102 (e.g., an AP), and the UL BA transmitted by the dSTA may acknowledge the soliciting DL A-MPDU/BAR from the rSTA.

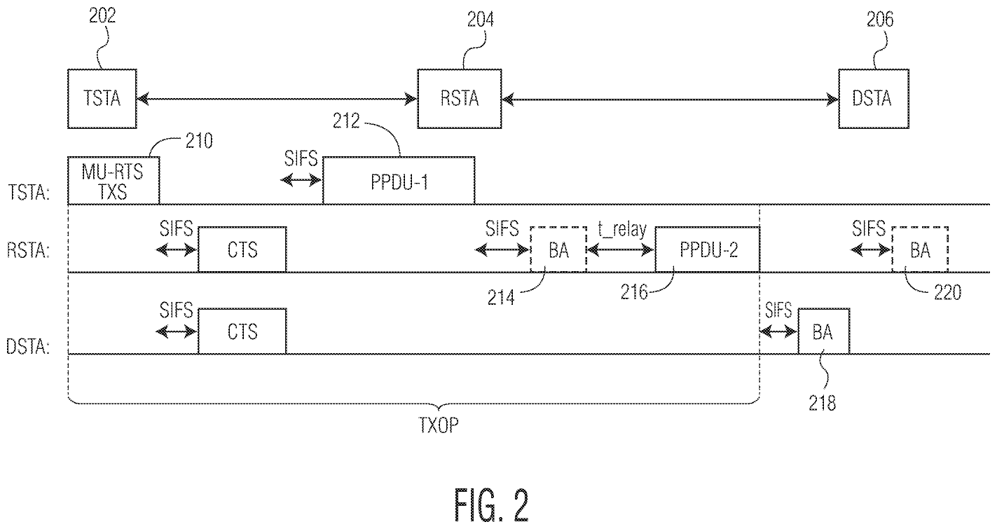

FIG. 2 depicts a frame exchange sequence diagram between a tSTA 202 (e.g., an AP), an rSTA 204, and a dSTA 206. In the frame exchange sequence diagram depicted in FIG. 2, the tSTA 202 may be implemented the same as or similar to the tSTA 102 depicted in FIG. 1, while the rSTA 204 and the dSTA 206 may be implemented the same as or similar to the rSTA 104 and the dSTA 106 depicted in FIG. 1, respectively. In the frame exchange sequence diagram depicted in FIG. 2, transmit opportunity (TXOP) sharing relay communications with one relay are implemented. A Multi User Request to Send (MU-RTS) triggered TXOP sharing (TXS) frame 210 may be sent by the tSTA 202 (e.g., an AP) to reserve the TXOP for both hops (i.e., the tSTA 202 and the rSTA 204), and a portion of the TXOP can be shared with the rSTA 204. The rSTA and/or the dSTA may transmit a Clear to Send (CTS) frame in response to the MU-RTS TXS frame. The tSTA 202 (e.g., an AP) transmits a Physical layer Protocol Data Unit (PPDU) PPDU-1 212 to the rSTA 204. For example, in the MU-RTS TXS frame, the tSTA 202 reserves a 5 milliseconds (ms) TXOP, out of which 3 ms is allocated to the rSTA, and the tSTA uses 2 ms for PPDU-1 212 transmission. The rSTA 204 can perform data forwarding by decoding and forwarding. The transmission of BA 214 from the rSTA back to the tSTA may be either skipped or performed if an end-to-end BA agreement is set up. The relay processing delay (t relay) is either pre-defined for any relays (e.g., being equal to Short Interframe Spacing (SIFS)), or per-determined by the rSTA. The rSTA forwards successfully received MPDUs carried in PPDU-1 in a Physical layer Protocol Data Unit (PPDU) PPDU-2 216 to the dSTA. The dSTA 206 sends a BA 218 back to the rSTA, which may send an optional BA 220 back to the tSTA 202. If an end-to-end BA is indicated as the tSTA (and the dSTA) being supported and/or if an end-to-end BA agreement is setup, the rSTA may send the optional BA 220 to the tSTA. Otherwise, the rSTA does not send the optional BA 220 to the tSTA. PPDU-2's Modulation and Coding Scheme (MCS)/number of spatial streams (NSS) may be informed to the RSTA with the information embedded in PPDU-1 or in a separate management frame. If the TXOP duration is not sufficient, the RSTA may choose to drop some MPDUs. In some embodiments, for point-to-point (P2P) communications, the tSTA is implemented as another non-AP STA. In some embodiments, the rSTA 204 includes a relay STA that performs frame exchanges with the tSTA 202 and a relay AP that performs frame exchanges with the dSTA 206 and a relay functionality between the relay STA and the relay AP.

While a MAC data frame and a MAC management frame can include four-address or three-address fields in a MAC header, a MAC control frame generally includes only two-address or one-address field. To support end-to-end acknowledgement for relay operation, a block acknowledgement (BA) frame should indicate receiver address (RA), transmitter address (TA), and destination address (DA)/source address (SA). However, a BA frame is a MAC Control frame which includes the RA field and the TA field, which cannot support end-to-end acknowledgement for relay. For example, if a destination station (dSTA) (e.g., non-AP STA) transmits a BA frame to an rSTA, the RA field may be set to the rSTA′ address and the TA field may be set to the dSTA′ address. Since there is no DA information in the BA frame received from the dSTA, an rSTA cannot forward the BA frame to the tSTA (e.g., an AP). If an rSTA transmits a BA frame to a tSTA (e.g., an AP), the RA field may be set to the tSTA's address and the TA field may be set to the rSTA's address. Since there is no SA information in the BA frame received from the rSTA, the tSTA does not know where the BA frame comes from.

In accordance with an embodiment of the invention, to support end-to-end acknowledgement for relay operation, a multi-STA block acknowledgement (BA or BlockAck) frame indicates receiver address (RA), transmitter address (TA), and destination address (DA)/source address (SA). In an embodiment, to indicate source address (SA) or destination address (DA) in a BA frame, a special Per Association Identifier (AID) Traffic Identifier (TID) Info subfield in the multi-STA BA frame can be used. In some embodiments, a dSTA transmits a multi-STA BA frame to an rSTA, and the multi-STA BA frame includes in the MAC header, the RA field set to the rSTA MAC address and the TA field set to the dSTA MAC address. In an embodiment, in a multi-STA BA variant, a special Per AID TID Info subfield indicates the DA subfield set to the tSTA MAC address (e.g., the STA MAC address where the multi-STA BA frame will be forwarded to). In some embodiments, the rSTA receiving the multi-STA BA frame forwards another multi-STA BA frame including in the MAC header, the RA field set to the tSTA MAC address and the TA field set to the rSTA MAC address. In an embodiment, in the multi-STA BA variant, a special Per AID TID Info subfield indicates the SA subfield set to the dSTA MAC address (e.g., the STA MAC address where the multi-STA BA frame was received from).

In some embodiments, a multi-STA BA frame is supported if either UL multi-user (MU) or multi-TID A-MPDU operation is supported and acknowledges MPDUs carried in a High-Efficiency (HE) trigger-based (TB) PPDU or multi-STA multi-TID, multi-STA single-TID, or single-STA multi-TID A-MPDUs. The multi-STA BA may include multiple Per AID TID Info subfields that can indicate multi-STA and multi-TID acknowledgement.

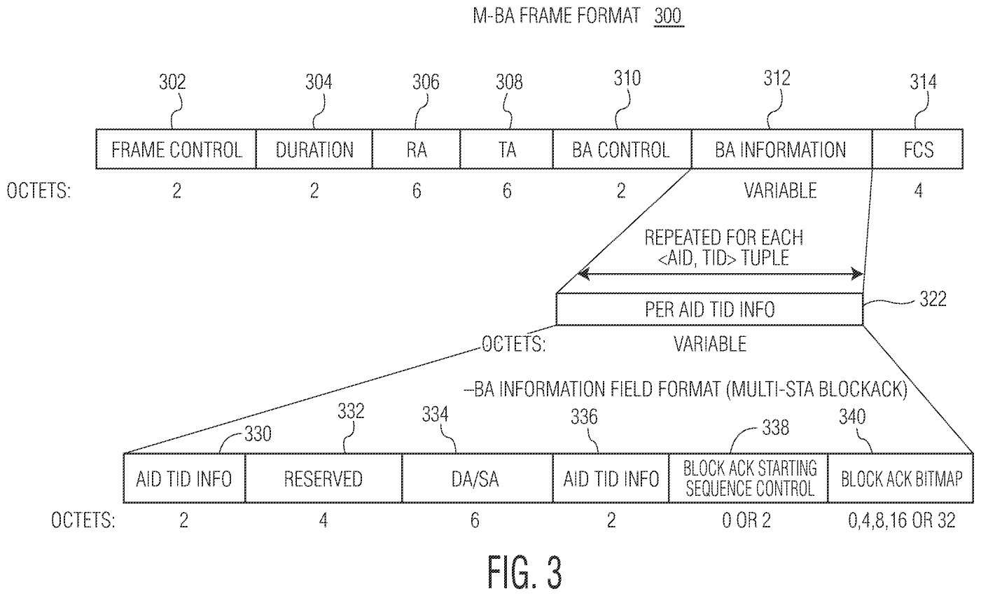

FIG. 3 depicts an example format of a multi-STA BA (also referred to as M-BA) frame 300. In the embodiment depicted in FIG. 3, the M-BA frame 300 includes a frame control field 302 (e.g., two-octet) that may contain frame control information, a frame duration field 304 (e.g., two-octet) that may contain frame duration information, a RA field 306 (e.g., six-octet) that may contain receiver address (RA) information, a TA field 308 (e.g., six-octet) that may contain transmitter address (TA) information, a BA control field 310 (e.g., two-octet) that may contain BA control information, a BA information field 312 that has a variable length, and a frame check sequence (FCS) field 314 (e.g., four-octet) that may contain frame check sequence information. In the embodiment depicted in FIG. 3, the BA information field 312 contains, for each <AID, TID> tuple or combination, Per AID TID Info field 322 that has a variable length. If/when Block Ack Bitmap information is indicated in the M-BA frame (e.g., multiple TID acknowledgement in response to A-MPDU), the following Per AID TID Info subfields can be included in the M-BA frame. In the embodiment depicted in FIG. 3, the Per AID TID Info field 322 includes a first Per AID TID Info subfield, which includes an AID TID Info field 330 (e.g., two-octet) that may contain AID and/or TID information, a reserved field 332 (e.g., four-octet) that may contain reserved information, a DA/SA field 334 (e.g., six-octet) that may contain destination address (DA) or source address (SA) information. A specific AID included in the AID TID Info subfield can be used to indicate inclusion of the DA/SA subfield. In some embodiments, the AID TID Info field 330 (2 Bytes) includes AID11(11 bit), Ack Type (1 bit), TID (4 bit)=Reserved. AID 11 subfield may be set to a specific value, such as, 2046, indicating the end-to-end relay acknowledgement. If AID 11 subfield is set to a specific value, such as, 2046, the Ack Type subfield indicates inclusion of the DA subfield or SA subfield (e.g., Ack Type equal to 0 indicates inclusion of the DA subfield and Ack Type equal to 1 indicates inclusion of the SA subfield). In the embodiment depicted in FIG. 3, the Per AID TID Info field 322 also includes a second Per AID TID Info subfield, which includes an AID TID Info field 336 (e.g., two-octet) that may contain AID and/or TID information, a block acknowledgement (BlockAck or BA) starting sequence control field 338 (e.g., zero octet or two-octet) that may contain block acknowledgement starting sequence control information, and a block acknowledgement (BlockAck or BA) bitmap field 340 (e.g., zero octet, four-octet, eight-octet, sixteen-octet, thirty-two-octet) that may contain block acknowledgement bitmap information. In some embodiments, the AID TID Info field 336 includes AID11=STA AID, Ack Type=BlockAck(0), TID=TID value. AID11 can be reserved or can be set to a receiver STA AID or set to a transmitter STA AID.

In some embodiments, if/when Ack is indicated in a M-BA frame (e.g., acknowledgement in response to a single MPDU), the following Per AID TID Info subfields, which include a first Per AID TID Info subfield and a second Per AID TID Info subfield, can be included in the M-BA frame. The first Per AID TID Info subfield includes an AID TID Info field (e.g., two-octet) that may contain AID and/or TID information, a reserved field (e.g., four-octet) that may contain reserved information, a DA/SA field (e.g., six-octet) that may contain destination address (DA) or source address (SA) information. In the first Per AID TID Info subfield, a specific AID included in the AID TID Info subfield can be used to indicate inclusion of the DA/SA subfield. In some embodiments, the AID TID Info field (2 Bytes) includes AID11(11 bit), Ack Type (1 bit), TID (4 bit)=Reserved. AID 11 subfield may be set to a specific value, such as, 2046, indicating the end-to-end relay acknowledgement. If AID 11 subfield is set to a specific value, such as, 2046, the Ack Type subfield indicates inclusion of the DA subfield or SA subfield (e.g., Ack Type equal to 0 indicates inclusion of the DA subfield and Ack Type equal to 1 indicates inclusion of the SA subfield). The second Per AID TID Info subfield includes an AID TID Info field (e.g., two-octet) that may contain AID and/or TID information. In some embodiments, the AID TID Info field includes AID11=STA AID, Ack Type=Ack(1), TID=TID or the value 15 indicating Ack for Management frame. AID11 can be reserved or can be set to a receiver STA AID or set to a transmitter STA AID.

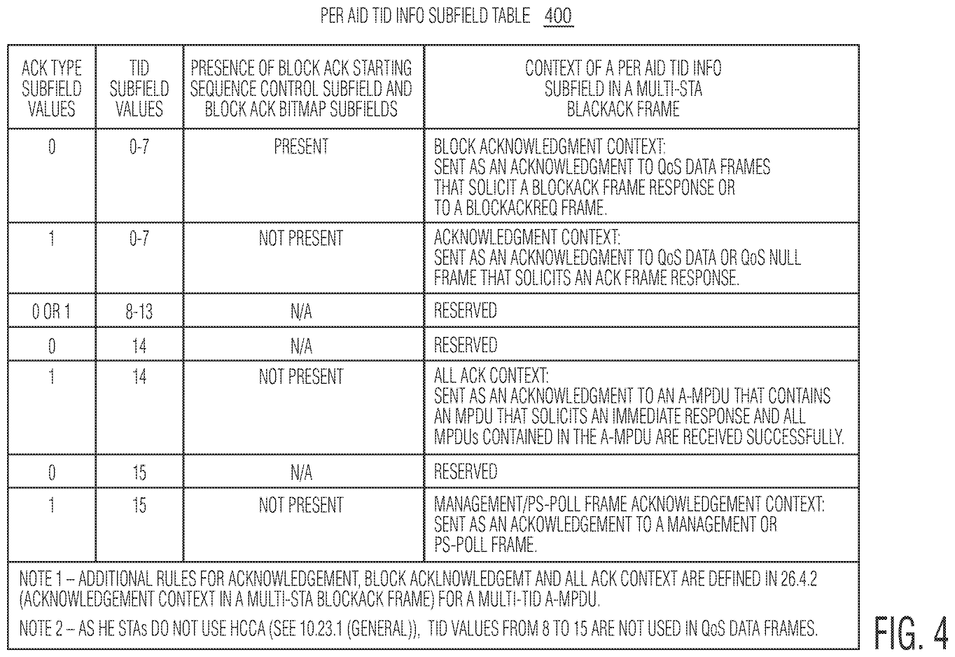

FIG. 4 depicts an example Per AID TID Info subfield table 400. In the Per AID TID Info subfield Table 400 depicted in FIG. 4, Ack type subfield values, TID subfield values, presence of Block Ack starting sequence control subfield and Block Ack bitmap subfields and context of a Per AID TID Info subfield.

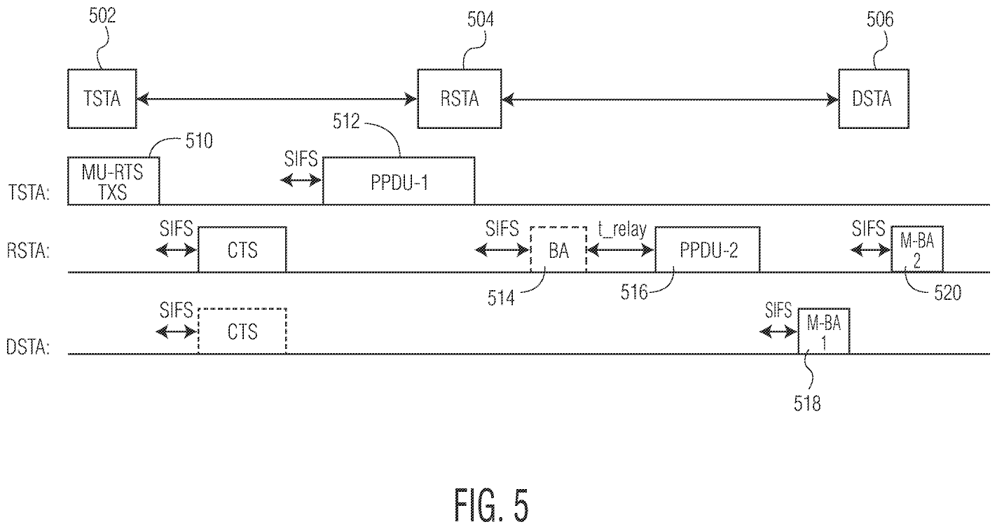

FIG. 5 depicts a frame exchange sequence diagram between a tSTA 502 (e.g., an AP), an rSTA 504, and a dSTA 506 with M-BAs. In the frame exchange sequence diagram depicted in FIG. 5, the tSTA 502 may be implemented the same as or similar to the tSTA 102 depicted in FIG. 1, while the rSTA 504 and the dSTA 506 may be implemented the same as or similar to the rSTA 104 and the dSTA 106 depicted in FIG. 1, respectively. In the frame exchange sequence diagram depicted in FIG. 5, transmit opportunity (TXOP) sharing relay communications with one relay are implemented. A Multi User Request to Send (MU-RTS) triggered TXOP sharing (TXS) frame 510 may be sent by the tSTA 502 (e.g., an AP) to reserve the TXOP for both hops (i.e., the tSTA 502 and the rSTA 504), and a portion of the TXOP can be shared with the rSTA 504. The rSTA and/or the dSTA may transmit a Clear to Send (CTS) frame in response to the MU-RTS TXS frame. The tSTA 502 (e.g., an AP) transmits a Physical layer Protocol Data Unit (PPDU) PPDU-1 512 to the rSTA 504. For example, in the MU-RTS TXS frame, the tSTA 502 reserves a 5 milliseconds (ms) TXOP, out of which 3 ms is allocated to the rSTA, and the tSTA uses 2 ms for PPDU-1 512 transmission. The rSTA 504 can perform data forwarding by decoding and forwarding. The transmission of BA 514 from the rSTA back to the tSTA may be either skipped or performed if an end-to-end BA agreement is set up. The relay processing delay (t relay) is either pre-defined for any relays (e.g., being equal to Short Interframe Spacing (SIFS)), or per-determined by the rSTA. The rSTA forwards successfully received MPDUs carried in PPDU-1 in a Physical layer Protocol Data Unit (PPDU) PPDU-2 516 to the dSTA. The dSTA 506 sends a M-BA frame 518 back to the rSTA, which may send a M-BA frame 520 back to the tSTA 502. PPDU-2's Modulation and Coding Scheme (MCS)/number of spatial streams (NSS) may be informed to the RSTA with the information embedded in PPDU-1 or in a separate management frame. If the TXOP duration is not sufficient, the RSTA may choose to drop some MPDUs. In some embodiments, for point-to-point (P2P) communications, the tSTA is implemented as another non-AP STA. In some embodiments, the rSTA 504 includes a relay STA that performs frame exchanges with the tSTA 502 and a relay AP that performs frame exchanges with the dSTA 506 and a relay functionality between the relay STA and the relay AP.

A first example of communications between the tSTA 502 (e.g., an AP), the rSTA 504, and the dSTA 506 is described as follows. The tSTA sends PPDU-1 (w/A-MPDU) to the rSTA with MAC Header Address RA: rSTA, TA: tSTA, DA: dSTA, SA: tSTA. The rSTA sends PPDU-2 (w/A-MPDU) to the dSTA with MAC Header Address: RA: dSTA, TA: rSTA, DA: dSTA, SA: tSTA. The dSTA sends M-BA 1 518 to the rSTA with RA=rSTA MAC address, TA=dSTA MAC address. The M-BA 1 518 includes Per AID TID Info field 1 with AID TID Info field (2 Byte), which includes AID11 (11 bit)=X (e.g., 2046), Ack Type(1 bit)=0, TID(4 bit)=Reserved, Reserved field (4 Byte), and DA field (6 Byte): tSTA MAC address. AID X can be used to indicate inclusion of the MAC address of destination STA. The M-BA 1 518 also includes Per AID TID Info field 2 with AID TID Info field, which includes AID11=Reserved, Ack Type=0, TID=TID value, Block Ack Starting Sequence Control field, and Block Ack Bitmap field. The rSTA sends the M-BA 2 frame 520 to the tSTA with RA: tSTA MAC address, TA: rSTA MAC address. The M-BA 2 frame 520 includes Per AID TID Info field 1 with AID TID Info field (2 Byte), which includes AID11 (11 bit)=X (e.g., 2046), Ack Type (1 bit)=1, TID (4 bit)=Reserved, Reserved field (4 Byte), and SA field (6 Byte): dSTA MAC address. The M-BA 2 frame 520 also includes Per AID TID Info field 2, which includes AID TID Info field, which includes AID11=tSTA AID, Ack Type=0, TID=TID value, Block Ack Starting Sequence Control field, and Block Ack Bitmap field.

A second example of communications between the tSTA 502 (e.g., an AP), the rSTA 504, and the dSTA 506 is described as follows. The tSTA sends PPDU-1 (w/A-MPDU) to the rSTA with MAC Header Address RA: rSTA, TA: tSTA, DA: dSTA, SA: tSTA. The rSTA sends PPDU-2 (w/A-MPDU) to the dSTA with MAC Header Address: RA: dSTA, TA: rSTA, DA: dSTA, SA: tSTA. The dSTA sends M-BA 1 518 to the rSTA with RA=rSTA MAC address, TA=dSTA MAC address. The M-BA 1 518 includes Per AID TID Info field 1 with AID TID Info field (2 Byte), which includes AID11 (11 bit)=X (e.g., 2046), Ack Type (1 bit)=0, TID (4 bit)=Reserved, Reserved field (4 Byte), and DA field (6 Byte): tSTA MAC address. AID X can be used to indicate inclusion of the MAC address of destination STA. The M-BA 1 518 also includes Per AID TID Info field 2 with AID TID Info field, which includes AID11=Reserved, Ack Type=1, TID=TID value. The rSTA sends the M-BA 2 frame 520 to the tSTA with RA: tSTA MAC address, TA: rSTA MAC address. The M-BA 2 frame 520 includes Per AID TID Info field 1 with AID TID Info field (2 Byte), which includes AID11 (11 bit)=X (e.g., 2046), Ack Type (1 bit)=1, TID (4 bit)=Reserved, Reserved field (4 Byte), and SA field (6 Byte): dSTA MAC address. The M-BA 2 frame 520 also includes Per AID TID Info field 2, which includes AID TID Info field, which includes AID11=reserved, Ack Type=1, TID=TID value.

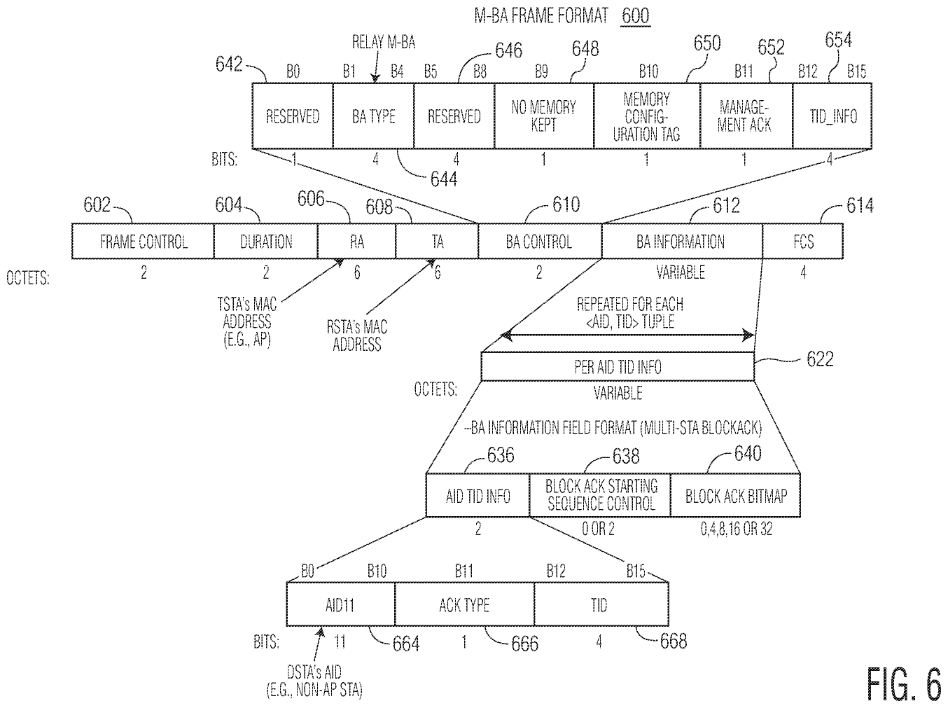

FIG. 6 depicts an example format of an M-BA frame 600. In the embodiment depicted in FIG. 6, the M-BA frame 600 is a relay M-BA frame that includes a frame control field 602 (e.g., two-octet) that may contain frame control information, a frame duration field 604 (e.g., two-octet) that may contain frame duration information, a RA field 606 (e.g., six-octet) that may contain receiver address (RA) information (e.g., a tSTA's MAC address, such as, an AP's MAC address), a TA field 608 (e.g., six-octet) that may contain transmitter address (TA) information (e.g., an rSTA's MAC address), a BA control field 610 (e.g., two-octet) that may contain BA control information, a BA information field 612 that has a variable length, and a FCS field 614 (e.g., four-octet) that may contain frame check sequence information. The relay M-BA can be indicated by a BA Type subfield 644 (e.g., one reserved value such as 12 in the BA Control field) and/or one reserved subfield 642 in the BA Control field. In some embodiments, the BA control field 610 includes a reserved subfield 642 (e.g., one-bit), the BA Type subfield 644 (e.g., four-bit) that may contain BA type information, a reserved subfield 646 (e.g., four-bit), a no memory kept subfield 648 (e.g., one-bit), a memory configuration tag subfield 650 (e.g., one-bit), a management Ack subfield 652 (e.g., one-bit), and a TLD_INFO (TLD stands for top level domain) subfield 654 (e.g., four-bit).

In the embodiment depicted in FIG. 6, the BA information field 612 contains, for each <AID, TID> tuple or combination, Per AID TID Info field 622 that has a variable length. In the embodiment depicted in FIG. 6, the Per AID TID Info field 622 includes a Per AID TID Info subfield, which includes an AID TID Info field 636 (e.g., two-octet) that may contain AID and/or TID information, a block acknowledgement (BlockAck or BA) starting sequence control field 638 (e.g., zero octet or two-octet) that may contain block acknowledgement starting sequence control information, and a block acknowledgement (BlockAck or BA) bitmap field 640 (e.g., zero octet, four-octet, eight-octet, sixteen-octet, thirty-two-octet) that may contain block acknowledgement bitmap information. In some embodiments, the AID TID Info field 336 includes an AID11 field 664 (e.g., dSTA's AID (e.g., non-AP STA), e.g., eleven-bit), an Ack Type field 666 (e.g., one-bit), and a TID field 668 (e.g., four-bit). The relay M-BA frame can include a single Per AID TID Info field as follows. If the RA field is set to a relay device's MAC address and the TA field is set to an AP's MAC address, the AID subfield in the AID TID Info subfield can be set to a non-AP STA's AID, which is a destination device of the relay M-BA frame. If the RA field is set to a non-AP STA's MAC address and the TA field is set to a relay device's MAC address, the AID11 subfield may be reserved. The non-AP STA may know that the relay M-BA frame is not a hop-by-hop BA frame but an end-to-end BA frame for the relay operation. If the RA field is set to an AP's MAC address and the TA field is set to a relay device's MAC address, the AID11 subfield in the AID TID Info subfield can be set to a non-AP STA's AID which is a source device of the relay M-BA frame.

In some embodiments, relay M-BA frames (i.e., M-BA 1 518, M-BA 2 520 in FIG. 5) may not be transmitted sequentially in a single TXOP. One of the relay M-BA frames can be transmitted solely depending on the direction of the relay operation (e.g., uplink (UL) relay transmission, downlink (DL) relay transmission). For example, during the DL relay transmission (e.g., for downlink data frames and/or management/action frames transmitted from an AP to a relay device and from the relay device to a non-AP STA), the non-AP STA may transmit to the relay device an existing BA frame (e.g., compressed BA, multi-TID BA, etc.) that includes the RA field set to a relay device's MAC address and the TA field set to a non-AP STA's MAC address. The relay device may transmit to the AP a Relay M-BA frame (e.g., M-BA 2) that includes the RA field set to an AP's MAC address, the TA field set to a relay device's MAC address and a source address information (e.g., a non-AP STA's AID or MAC address). In another example, during the UL relay transmission (e.g., for uplink data frames and/or management/action frames transmitted from a non-AP STA to a relay device and from the relay device to an AP), the AP that receives uplink data/management/action frames from the relay device may transmit to the relay device a relay M-BA frame (e.g., M-BA 1) that includes the RA field set to a relay device's MAC address, the TA field set to an AP's MAC address and a destination address information (e.g., a non-AP STA's AID or MAC address). The relay device that receives the relay M-BA frame may transmit to the non-AP STA a relay M-BA frame (e.g., M-BA 2, but with or without a source address information) that includes the RA field set to a non-AP STA's MAC address, the TA field set to a relay device's MAC address and an indication of the relay M-BA frame.

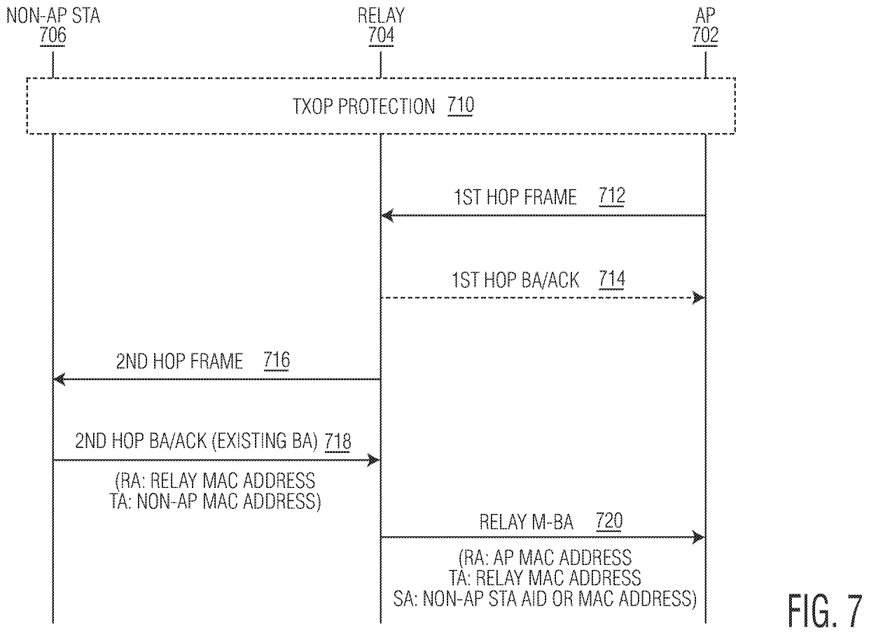

FIG. 7 shows a swim-lane diagram illustrating an example acknowledgement procedure between an AP 702, a relay 704, and a non-AP STA 706. The AP 702 may be an embodiment of the tSTA 102 depicted in FIG. 1, the tSTA 202 depicted in FIG. 2, and/or the tSTA 502 depicted in FIG. 5. The relay 704 may be an embodiment of the rSTA 104 depicted in FIG. 1, the rSTA 204 depicted in FIG. 2, and/or the rSTA 504 depicted in FIG. 5. The non-AP STA 706 may be an embodiment of the dSTA 106 depicted in FIG. 1, the dSTA 206 depicted in FIG. 2, and/or the dSTA 506 depicted in FIG. 5. Although operations in the example procedure in FIG. 7 are described in a particular order, in some embodiments, the order of the operations in the example procedure may be altered so that certain operations may be performed in an inverse order or so that certain operations may be performed, at least in part, concurrently with other operations. At operation 710, a TXOP protection operation may be performed. At operation 712, a first hop frame is sent from the AP 702 to the relay 704. At operation 714, a first hop BA/Ack may be sent from the relay 704 to the AP 702. At operation 716, a second hop frame is sent from the relay 704 to the non-AP STA 706. At operation 718, a second hop BA/Ack is sent from the non-AP STA 706 to the relay 704 with relay MAC address as the RA and non-AP STA MAC address as the TA. At operation 720, a relay M-BA is sent from the relay 704 to the AP 702 with AP MAC address as the RA, relay MAC address as the TA, and non-AP STA AID or MAC address as the SA. The relay M-BA can be an M-BA 2 520 depicted in FIG. 5 or a relay M-BA 600 depicted in FIG. 6.

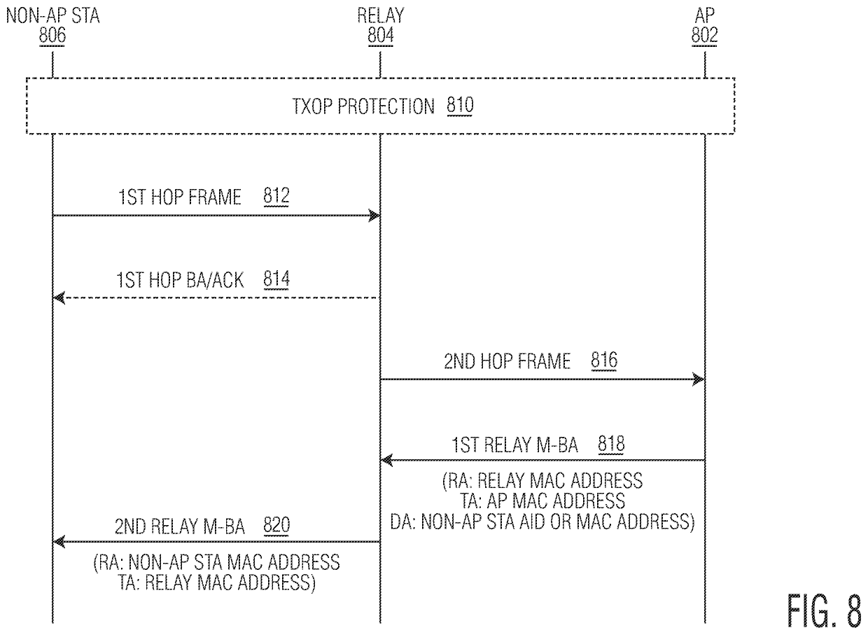

FIG. 8 shows a swim-lane diagram illustrating an example acknowledgement procedure between an AP 802, a relay 804, and a non-AP STA 806. The AP 802 may be an embodiment of the tSTA 102 depicted in FIG. 1, the tSTA 202 depicted in FIG. 2, and/or the tSTA 502 depicted in FIG. 5. The relay 804 may be an embodiment of the rSTA 104 depicted in FIG. 1, the rSTA 204 depicted in FIG. 2, and/or the rSTA 504 depicted in FIG. 5. The non-AP STA 806 may be an embodiment of the dSTA 106 depicted in FIG. 1, the dSTA 206 depicted in FIG. 2, and/or the dSTA 506 depicted in FIG. 5. Although operations in the example procedure in FIG. 8 are described in a particular order, in some embodiments, the order of the operations in the example procedure may be altered so that certain operations may be performed in an inverse order or so that certain operations may be performed, at least in part, concurrently with other operations. At operation 810, a TXOP protection operation may be performed. At operation 812, a first hop frame is sent from the non-AP STA 806 to the relay 804. At operation 814, a first hop BA/Ack may be sent from the relay 804 to the non-AP STA 806. At operation 816, a second hop frame is sent from the relay 804 to the AP 802. At operation 818, a first relay M-BA is sent from the AP 802 to the relay 804 with relay MAC address as the RA, AP MAC address as the TA, and non-AP STA AID or MAC address as the DA. The first relay M-BA can be either an M-BA 1 518 depicted in FIG. 5 or a relay M-BA depicted in FIG. 6. At operation 820, a second relay M-BA is sent from the relay 704 to the non-AP STA 806 with non-AP STA MAC address as the RA, relay MAC address as the TA. The second relay M-BA can be either an M-BA 2 520 depicted in FIG. 5 or a relay M-BA depicted in FIG. 6, where the M-BA 2 520 includes an indication of the relay M-BA with or without a source address (e.g., AP address) information, or the relay M-BA that includes the AID 11 subfield in the AID TID Info field set to the non-AP STA's AID or a reserved value.

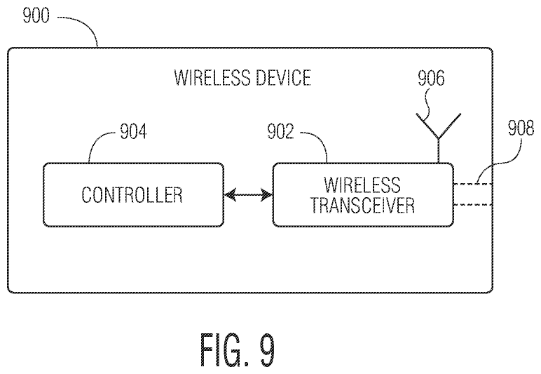

FIG. 9 depicts a wireless device 900 in accordance with an embodiment of the invention. The wireless device 900 can be used in the wireless communications system 100 depicted in FIG. 1. For example, the wireless device 900 may be an embodiment of the tSTA 102, the rSTA 104, and/or the dSTA 106 depicted in FIG. 1, the tSTA 202, the rSTA 204, and/or the dSTA 206 depicted in FIG. 2, the tSTA 502, the rSTA 504, and/or the dSTA 506 depicted in FIG. 5, the AP 702, the relay 704, and/or the non-AP STA 706 depicted in FIG. 7, and/or the AP 802, the relay 804, and/or the non-AP STA 806 depicted in FIG. 8. However, the tSTA 102, the rSTA 104, and/or the dSTA 106 depicted in FIG. 1, the tSTA 202, the rSTA 204, and/or the dSTA 206 depicted in FIG. 2, the tSTA 502, the rSTA 504, and/or the dSTA 506 depicted in FIG. 5, the AP 702, the relay 704, and/or the non-AP STA 706 depicted in FIG. 7, and/or the AP 802, the relay 804, and/or the non-AP STA 806 depicted in FIG. 8 are not limited to the embodiment depicted in FIG. 9.

In the embodiment depicted in FIG. 9, the wireless device 900 includes a wireless transceiver 902, a controller 904 operably connected to the wireless transceiver, and at least one antenna 906 operably connected to the wireless transceiver. In some embodiments, the wireless device 900 may include at least one optional network port 908 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 900 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port. In some embodiments, the wireless device is compatible with an Institute of Electrical and Electronics Engineers (IEEE) 802.11 protocol. In some embodiments, the wireless device is compatible with an Institute of Electrical and Electronics Engineers (IEEE) 802.11be protocol. In some embodiments, the wireless device is a component of a multi-link device (MLD).

The wireless device 900 may be a wireless relay device. In some embodiments, the wireless device 900 is a dedicated relay device. In some embodiments, the wireless device 900 is a non-AP wireless station with a relaying function enabled. In some embodiments, the wireless device 900 is an AP with a relaying function enabled. For example, the wireless device 900 may be an embodiment of the rSTA 104 depicted in FIG. 1, the rSTA 204 depicted in FIG. 2, the rSTA 504 depicted in FIG. 5, the relay 704 depicted in FIG. 7, and/or the relay 804 depicted in FIG. 8. However, the rSTA 104 depicted in FIG. 1, the rSTA 204 depicted in FIG. 2, the rSTA 504 depicted in FIG. 5, the relay 704 depicted in FIG. 7, and/or the relay 804 depicted in FIG. 8 are not limited to the embodiment depicted in FIG. 9. In accordance with an embodiment of the invention, the wireless transceiver 902 is configured to receive, from a first wireless device, a first block acknowledgement (BA) frame and the controller 904 is configured to generate a second BA frame in response to the first BA frame. The wireless transceiver is further configured to transmit the second BA frame to a second wireless device. In some embodiments, at least one of the first BA frame and the second BA frame includes a receiver address (RA), a transmitter address (TA), and one of a source address (SA) and a destination address (DA). In some embodiments, the SA or the DA is indicated in a Per Association Identifier (AID) Traffic Identifier (TID) information subfield in the at least one of the first BA frame and the second BA frame. In some embodiments, the first and the second BA frames include Media Access Control (MAC) control frames. In some embodiments, at least one of the first BA frame and the second BA frame includes a multi-station (STA) BA frame. In some embodiments, the first and the second BA frames include address fields indicating MAC addresses of the first wireless device and the second wireless device. In some embodiments, the second wireless device includes a wireless access point (AP), and the first wireless device includes a non-AP STA device. In some embodiments, the first BA frame includes a MAC header having a receiver address (RA) field that is set to a MAC address of the wireless relay device and a transmitter address (TA) field that is set to a MAC address of the non-AP STA device. In some embodiments, the first BA frame includes a Per Association Identifier (AID) Traffic Identifier (TID) information subfield having a destination address (DA) field that is set to a MAC address of the wireless AP. In some embodiments, the second BA frame includes a MAC header having a receiver address (RA) field that is set to a MAC address of the wireless AP and a transmitter address (TA) field that is set to a MAC address of the wireless relay device. In some embodiments, the second BA frame includes a Per Association Identifier (AID) Traffic Identifier (TID) information subfield having a source address (SA) field that is set to a MAC address of the wireless non-AP STA device. In some embodiments, the first wireless device includes a wireless access point (AP), and the second wireless device includes a non-AP station (STA) device. In some embodiments, the wireless relay device is compatible with an Institute of Electrical and Electronics Engineers (IEEE) 802.11 protocol. In some embodiments, the wireless transceiver is further configured to share a transmit opportunity (TXOP) of the second wireless device. In some embodiments, the wireless transceiver is further configured to share the TXOP of the second wireless device in a multi-hop transmission, wherein the multi-hop transmission is conducted through an aggregated physical layer protocol data unit (PPDU). In some embodiments, the aggregated PPDU includes a first PPDU and a second PPDU that is a relayed version of the first PPDU.

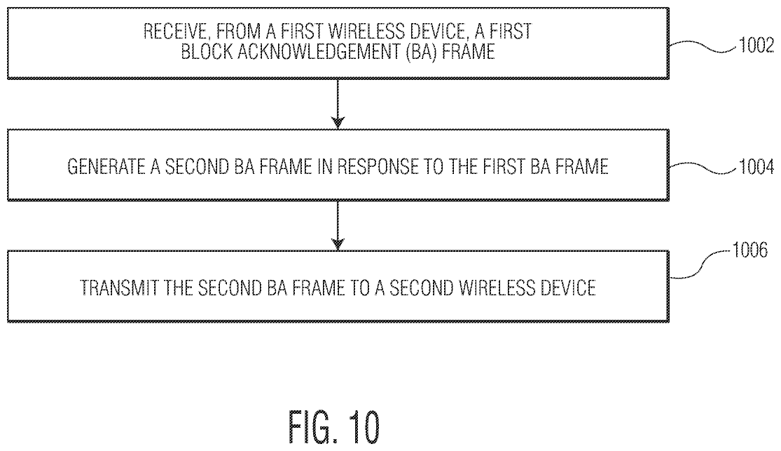

FIG. 10 is a process flow diagram of a method for wireless communications in accordance with an embodiment of the invention. At block 1002, from a first wireless device, a first block acknowledgement (BA) frame is received. At block 1004, a second BA frame is generated in response to the first BA frame. At block 106, the second BA frame is transmitted to a second wireless device. The first wireless device and/or the second wireless device may be the same as or similar to the tSTA 102, the rSTA 104, and/or the dSTA 106 depicted in FIG. 1, the tSTA 202, the rSTA 204, and/or the dSTA 206 depicted in FIG. 2, the tSTA 502, the rSTA 504, and/or the dSTA 506 depicted in FIG. 5, the AP 702, the relay 704, and/or the non-AP STA 706 depicted in FIG. 7, and/or the AP 802, the relay 804, and/or the non-AP STA 806 depicted in FIG. 8.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless relay device comprising:
a wireless transceiver configured to receive, from a first wireless device, a first block acknowledgement (BA) frame; and
a controller configured to generate a second BA frame in response to the first BA frame,
wherein the wireless transceiver is further configured to transmit the second BA frame to a second wireless device.

2. The wireless relay device of claim 1, wherein at least one of the first BA frame and the second BA frame comprises a receiver address (RA), a transmitter address (TA), and one of a source address (SA) and a destination address (DA).

3. The wireless relay device of claim 2, wherein the SA or the DA is indicated in a Per Association Identifier (AID) Traffic Identifier (TID) information subfield in the at least one of the first BA frame and the second BA frame.

4. The wireless relay device of claim 1, wherein the first and the second BA frames comprise a plurality of Media Access Control (MAC) control frames.

5. The wireless relay device of claim 1, wherein at least one of the first BA frame and the second BA frame comprises a multi-station (STA) BA frame.

6. The wireless relay device of claim 1, wherein the first and the second BA frames comprise a plurality of address fields indicating a plurality of Media Access Control (MAC) addresses of the first wireless device and the second wireless device.

7. The wireless relay device of claim 1, wherein the second wireless device comprises a wireless access point (AP), and wherein the first wireless device comprises a non-AP station (STA) device.

8. The wireless relay device of claim 7, wherein the first BA frame comprises a Media Access Control (MAC) header having a receiver address (RA) field that is set to a MAC address of the wireless relay device and a transmitter address (TA) field that is set to a MAC address of the non-AP STA device.

9. The wireless relay device of claim 8, wherein the first BA frame comprises a Per Association Identifier (AID) Traffic Identifier (TID) information subfield having a destination address (DA) field that is set to a MAC address of the wireless AP.

10. The wireless relay device of claim 7, wherein the second BA frame comprises a Media Access Control (MAC) header having a receiver address (RA) field that is set to a MAC address of the wireless AP and a transmitter address (TA) field that is set to a MAC address of the wireless relay device.

11. The wireless relay device of claim 10, wherein the second BA frame comprises a Per Association Identifier (AID) Traffic Identifier (TID) information subfield having a source address (SA) field that is set to a MAC address of the wireless non-AP STA device.

12. The wireless relay device of claim 1, wherein the first wireless device comprises a wireless access point (AP), and wherein the second wireless device comprises a non-AP station (STA) device.

13. The wireless relay device of claim 1, wherein the wireless relay device is compatible with an Institute of Electrical and Electronics Engineers (IEEE) 802.11 protocol.

14. The wireless relay device of claim 1, wherein the wireless transceiver is further configured to share a transmit opportunity (TXOP) of the second wireless device.

15. The wireless relay device of claim 14, wherein the wireless transceiver is further configured to share the TXOP of the second wireless device in a multi-hop transmission, wherein the multi-hop transmission is conducted through an aggregated physical layer protocol data unit (PPDU).

16. The wireless relay device of claim 15, wherein the aggregated PPDU comprises a first PPDU and a second PPDU that is a relayed version of the first PPDU.

17. A method for wireless communications:
receiving, from a first wireless device, a first block acknowledgement (BA) frame;
generating a second BA frame in response to the first BA frame; and
transmitting the second BA frame to a second wireless device,
wherein at least one of the first BA frame and the second BA frame comprises a multi-station (STA) BA frame having a receiver address (RA), a transmitter address (TA), and one of a source address (SA) and a destination address (DA), and wherein the first and the second BA frames comprise a plurality of Media Access Control (MAC) control frames.

18. The method of claim 17, wherein the SA or the DA is indicated in a Per Association Identifier (AID) Traffic Identifier (TID) information subfield in the at least one of the first BA frame and the second BA frame.

19. The method of claim 17, wherein the first and the second BA frames comprise a plurality of address fields indicating a plurality of Media Access Control (MAC) addresses of the first wireless device and the second wireless device.

20. The method of claim 17, wherein the second wireless device comprises a wireless access point (AP), and wherein the first wireless device comprises a non-AP station (STA) device.
